(19) United States
(12) Patent Application Publication
(10) Pub. No.: US 2018/0126706 A1
(43) Pub. Date: May 10, 2018

(54) SILICONE-BASED ASSEMBLY LAYERS FOR FLEXIBLE DISPLAY APPLICATIONS

(71) Applicant: 3M INNOVATIVE PROPERTIES COMPANY, St. Paul, MN (US)

(72) Inventors: Belma Erdogan-Haug, Woodbury, MN (US); Albert I. Everaerts, Tucson, AZ (US); David S. Hays, Woodbury, MN (US); David J. Kinning, Woodbury, MN (US); Maria A. Appeaning, St. Paul, MN (US); Jong-Seob Won, Gyeonggi-do (KR)

(21) Appl. No.: 15/575,524

(22) PCT Filed: May 31, 2016
(86) PCT No.: PCT/US2016/035008

§ 371 Date: Nov. 20, 2017

Related U.S. Application Data
(60) Provisional application No. 62/170,527, filed on Jun. 3, 2015.

(51) Int. Cl. B32B 25/20; B32B 25/08; B32B 25/14; B32B 7/04; B32B 27/26; B32B 7/02; B32B 27/28; B32B 27/08

(52) U.S. Cl. CPC B32B 25/20; B32B 2457/20; B32B 25/14; B32B 7/04; B32B 27/26; B32B 7/02; B32B 27/28; B32B 27/08; B32B 2250/05; B32B 2250/03; B32B 2250/40; B32B 2307/51; B32B 2307/542; B32B 2307/548; B32B 2307/546; B32B 2307/412; B32B 25/08

(57) ABSTRACT

The present invention is an assembly layer for a flexible device. The assembly layer is derived from precursors in eluding at least one of a physically cross-linked silicone elastomer and a covalently cross-linked silicone elastomer forming reagent mixture, and a MQ resin. Within a temperature range of between about −30 C to about 90 C, the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

### FIELD OF THE INVENTION

The present invention is related generally to the field of flexible assembly layers. In particular, the present invention is related to a silicone-based flexible assembly layer.

### BACKGROUND

A common application of pressure-sensitive adhesives in the industry today is in the manufacturing of various displays, such as computer monitors, TVs, cell phones and small displays (in cars, appliances, wearables, electronic equipment, etc.). Flexible electronic displays, where the display can be bent freely without cracking or breaking, is a rapidly emerging technology area for making electronic devices using, for example, flexible plastic substrates. This technology allows integration of electronic functionality into non-planar objects, conformity to desired design, and flexibility during use that can give rise to a multitude of new applications.

With the emergence of flexible electronic displays, there is an increasing demand for adhesives, and particularly for optically clear adhesives (OCA), to serve as an assembly layer or gap filling layer between an outer cover lens or sheet (based on glass, PET, PC, PMMA, polyimide, PEN, cyclic olefin copolymer, etc.) and an underlying display module of electronic display assemblies. The presence of the OCA improves the performance of the display by increasing brightness and contrast, while also providing structural support to the assembly. In a flexible assembly, the OCA will also serve at the assembly layer, which in addition to the typical OCA functions, may also absorb most of the folding induced stress to prevent damage to the fragile components of the display panel and protect the electronic components from breaking under the stress of folding. The OCA layer may also be used to position and retain the neutral bending axis at or at least near the fragile components of the display, such as for example the barrier layers, the driving electrodes, or the thin film transistors of an organic light emitting display (OLED).

If used outside of the viewing area of a display or photo-active area of a photovoltaic assembly, it is not necessary that the flexible assembly layer is optically clear. Indeed, such material may still be useful for example as a sealant at the periphery of the assembly to allow movement of the substrates while maintaining sufficient adhesion to seal the device.

Typical OCAs are visco-elastic in nature and are meant to provide durability under a range of environmental exposure conditions and high frequency loading. In such cases, a high level of adhesion and some balance of visco-elastic property is maintained to achieve good pressure-sensitive behavior and incorporate damping properties in the OCA. However, these properties are not fully sufficient to enable foldable or durable displays.

Due to the significantly different mechanical requirements for flexible display assemblies, there is a need to develop novel adhesives for application in this new technology area. Along with conventional performance attributes, such as optical clarity, adhesion, and durability, these OCAs need to meet a new challenging set of requirements such as bendability and recoverability without defects and delamination.

### SUMMARY

The present invention is an assembly layer for a flexible device. The assembly layer is derived from precursors including at least one of a physically cross-linked silicone elastomer and a covalently cross-linked silicone elastomer forming reagent mixture and a MQ resin. Within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

In another embodiment, the present invention is a laminate including a first substrate, a second substrate, and an assembly layer positioned between and in contact with the first substrate and the second substrate. The assembly layer is derived from precursors including at least one of a physically cross-linked silicone elastomer and a covalently cross-linked silicone elastomer forming reagent mixture and a MQ resin. Within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

In yet another embodiment, the present invention is a method of adhering a first substrate and a second substrate, wherein both of the first and the second substrates are flexible. The method includes positioning an assembly layer between the first substrate and the second substrate and applying pressure and/or heat to form a flexible laminate. The assembly layer is derived from precursors including at least one of a physically cross-linked silicone elastomer and a covalently cross-linked silicone elastomer forming reagent mixture and a MQ resin. Within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

### BRIEF DESCRIPTION OF THE DRAWINGS

FIG. 1 is a photograph of a fixture used in a static folding test of laminates including assembly layers of the present invention and graphs showing the initial angle and the angular recovery at 135° included angle, and 180° included angle.

FIG. 2 is a photograph of an apparatus used in a dynamic folding test for performing 180° bend testing of laminates including assembly layers of the present invention.

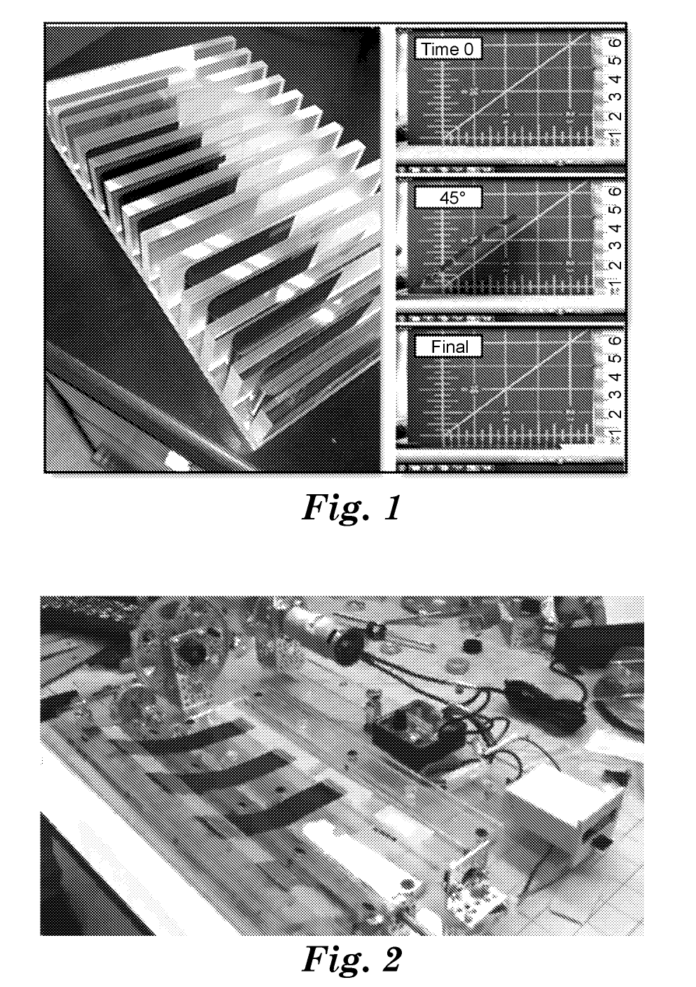

### DETAILED DESCRIPTION

The present invention is a silicone-based assembly layer usable, for example, in a flexible devices, such as electronic displays, flexible photovoltaic cells or solar panels, and wearable electronics. As used herein, the term “assembly layer” refers to a layer that possesses the following properties: (1) adherence to at least two flexible substrates and (2) sufficient ability to hold onto the adherends during repeated flexing to pass the durability testing. As used herein, a “flexible device” is defined as a device that can undergo repeated flexing or roll up action with a bend radius as low as 200 mm, 100 mm, 50 mm, 20 mm, 10 mm, 5 mm, or even less than 2 mm. The silicone-based assembly layer is soft, is predominantly elastic with good adhesion to plastic films or other flexible substrates like glass, and has high tolerance for shear loading. In addition, the silicone-based assembly layer has relatively low modulus, high percent compliance at moderate stress, a low glass transition temperature, generation of minimal peak stress during folding, and good strain recovery after applying and removing stress, making it suitable for use in a flexible assembly because of its ability to withstand repeated folding and unfolding. Under repeated flexing or rolling of a multi-layered construction, the shear loading on the adhesive layers becomes very significant and any form of stress can cause not only mechanical defects (delamination, buckling of one or more layers, cavitation bubbles in the adhesive, etc.) but also optical defects or Mura. Unlike traditional adhesives that are mainly visco-elastic in character, the silicone-based assembly layer of the present invention is predominantly elastic at use conditions, yet maintains sufficient adhesion to pass a range of durability requirements. In one embodiment, the silicone-based assembly layer is optically clear and exhibits low haze, high visible light transparency, anti-whitening behavior, and environmental durability.

The silicone-based assembly layer of the present invention is prepared from select silicone elastomer and MQ resin compositions and cross-linked at different levels to offer a range of elastic properties while still generally meeting all optically clear requirements. For example, a silicone-based assembly layer used within a laminate with a folding radius as low as 5 mm or less can be obtained without causing delamination or buckling of the laminate or bubbling of the adhesive. In one embodiment, the silicone-based assembly layer composition is derived from precursors that include a physically and/or covalently cross-linked silicone and a MQ resin.

The term “silicone-based” as used herein refers to macromolecules (e.g., polymer or copolymer) that contain silicone units. The terms silicone or siloxane are used interchangeably and refer to units with a siloxane (—Si(R¹)₂O—) repeating units where R¹ is defined below. In many embodiments, R¹ is an alkyl.

In one embodiment, silicone elastomers useful in the present invention include both physically cross-linked silicones and covalently cross-linked silicone elastomers. Suitable silicone elastomeric polymers include for example, urea-based silicone copolymers, oxamide-based silicone copolymers, amide-based silicone copolymers, urethane-based silicone copolymers, and mixtures thereof. The term “urea-based” as used herein refers to macromolecules that are segmented copolymers which contain at least one urea linkage. The term “amide-based” as used herein refers to macromolecules that are segmented copolymers which contain at least one amide linkage. The term “urethane-based” as used herein refers to macromolecules that are segmented copolymers which contain at least one urethane linkage. For example, silicone polyurea and silicone polyoxamides are particularly suitable in the present invention.

In such physically cross-linked elastomeric silicones, the silicone is the softer segment and the urea, amide, oxamide, urethane segments form the organic segments. At least some of the organic segments are immiscible with the silicone segment of the material and they have sufficiently high level of immiscibility and physical interaction amongst each other to keep the silicone polymer physically cross-linked over at least the use temperature of the flexible assembly layer. The molecular weight of the polymer backbone (silicone and any organic segment that is not engaged in physical crosslinking) between the phase-separated and physically crosslinking organic segments dictates the crosslink density of the physically cross-linked silicone elastomer. The molecular weight between the phase-separated and physically crosslinking organic segments is typically at least 15,000 Dalton, at least 20,000 Dalton, at least 25,000 Dalton, at least 30,000 Dalton, or at least 35,000 Dalton. The upper limit of the molecular weight between the phase-separated and physically crosslinking organic segments is only limited by the amount of the phase-separated and physically crosslinking organic segments necessary to retain the elastomeric properties of the silicone material. If desired, the elastomeric silicone can also be covalently cross-linked, for example, through terminal or pendant vinyl groups, acrylate groups, silane groups, and the like, provided the average molecular weight between the phase-separated and physically cross-linking organic segments, and the covalent cross-linked sites does not substantially decrease and thus the crosslink density of the original physically cross-linked silicone elastomer does not substantially increase.

One example of a useful class of silicone elastomeric polymers is urea-based silicone polymers such as silicone polyurea block copolymers. Silicone polyurea block copolymers are the reaction product of a polydiorganosiloxane diamine (also referred to as a silicone diamine), a polyisocyanate, and optionally an organic polyamine. As used herein, the term “polyisocyanate” refers to a compound having more than one isocyanate group. As used herein, the term “polyamine” refers to a compound having more than one amino group.

Suitable silicone polyurea block copolymers are represented by the repeating unit of Formula

### (I).

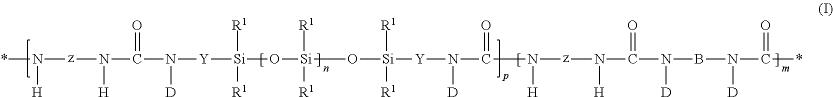

In Formula (I), each R¹ is independently an alkyl, haloalkyl, alkenyl, aralkyl, aryl, or aryl substituted with an alkyl, alkoxy, or halo. Suitable alkyl groups for R¹ in Formula (I) typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ often have an aryl group having 6 to 12 carbon atoms and an alkyl group having 1 to 10 carbon atoms. Exemplary aralkyl groups include a phenyl group with an alkyl group having 1 to 10 carbon atoms, 1 to 6 carbon atoms, or 1 to 4 carbon atoms.

In many embodiments, at least 50 percent of the R¹ groups are usually methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, aralkyl, alkenyl, aryl, or aryl substituted with an alkyl, or alkoxy. For example, all the R¹ groups can be an alkyl.

Each group Z in Formula (I) is independently an arylene, aralkylene, or alkylene. Exemplary arylenes have 6 to 20 carbon atoms and exemplary aralkylenes have 7 to 20 carbon atoms. The arylenes and aralkylenes can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). The alkylenes can be linear branch, cyclic, or combinations thereof and can have 1 to 20 carbon atoms. In some embodiments Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylene, 1,6-hexamethylene, 1,4-cyclohexylene, 2,2,4-trimethylhexylene, and mixtures thereof.

Each Y in Formula (I) is independently an alkylene having 1 to 10 carbon atoms, an aralkylene having 7 to 20 carbon atoms, or an arylene having 6 to 20 carbon atoms. Each D is selected from hydrogen, an alkyl having 1 to 10 carbon atoms, an aryl having 6 to 12 carbon atoms, or a radical that completes a ring structure including B or Y to form a heterocycle. Each D is often hydrogen or an alkyl group. Group B is selected from an alkylene, aralkylene, arylene such as phenylene, or heteroalkylene. Examples of heteroalkylenes include polyethylene oxide, polypropylene oxide, polytetramethylene oxide, and copolymers and mixtures thereof. The variable m is a number that is 0 to about 1000; p is a number that is at least 1; and n is a number in the range of 0 to 1500.

The term “alkyl” refers to a monovalent group that is a radical of an alkane, which is a saturated hydrocarbon. The alkyl can be linear, branched, cyclic, or combinations thereof and typically has 1 to 20 carbon atoms.

The term “haloalkyl” refers to an alkyl having at least one hydrogen atom replaced with a halo. The term “halo” refers to fluoro, chloro, bromo, or iodo. Some haloalkyl groups are fluoroalkyl groups, chloroalkyl groups, and bromoalkyl groups. The term “perfluoroalkyl” refers to an alkyl group in which all hydrogen atoms are replaced by fluorine atoms.

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 20 carbon atoms.

The term “aralkyl” refers to an alkyl group that is substituted with an aryl. Suitable aralkyl groups for R¹ often have an alkyl group with 1 to 10 carbon atoms and an aryl group with 6 to 12 carbon atoms.

The term “aryl” refers to a monovalent group that is aromatic and carbocyclic. The aryl can have one to five rings that are connected to or fused to the aromatic ring.

The other ring structures can be aromatic, non-aromatic, or combinations thereof.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroarylene” refers to a divalent group that is carbocyclic and aromatic and contains heteroatoms such as sulfur, oxygen, nitrogen or halogens such as fluorine, chlorine, bromine or iodine.

The term “aralkylene” refers to a divalent group of formula —R^{a}—Ar^{a}— where R^{a} is an alkylene and Ar^{a} is an arylene (i.e., an alkylene is bonded to an arylene).

Useful silicone polyurea block copolymers are disclosed in, e.g., U.S. Pat. No. 5,512,650 (Leir et al.), U.S. Pat. No. 5,214,119 (Leir et al.), U.S. Pat. No. 5,461,134 (Leir et al.), U.S. Pat. No. 6,407,195 (Sherman et al.), U.S. Pat. No. 6,441,118 (Sherman et al.), U.S. Pat. No. 6,846,893 (Sherman et al.), and U.S. Pat. No. 7,153,924 (Kuepfer et al.) as well as in PCT Publication No. WO 97/40103 (Paulick et al.).

Examples of useful silicone diamines that can be used in the preparation of silicone polyurea block copolymers include polydiorganosiloxane diamines represented by Formula (II)

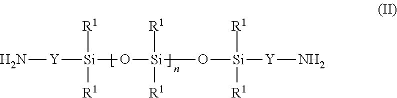

In Formula (II), each R¹ is independently an alkyl, haloalkyl, aralkyl, alkenyl, aryl, or aryl substituted with an alkyl, alkoxy, or halo as defined above for Formula (I). Each Y is independently an alkylene, arylene, or aralkylene as defined above for Formula (I). The variable n is an integer of 0 to 1500.

The polydiorganosiloxane diamine of Formula (II) can be prepared by any known method and can have any suitable molecular weight, such as a weight average molecular weight in the range of 700 to 150,000 g/mole. Suitable polydiorganosiloxane diamines and methods of making the polydiorganosiloxane diamines are described, for example, in U.S. Pat. No. 3,890,269 (Martin), U.S. Pat. No. 4,661,577 (Lane et al.), U.S. Pat. No. 5,026,890 (Webb et al.), U.S. Pat. No. 5,276,122 (Aoki et al.), U.S. Pat. No. 5,214,119 (Leir et al.), U.S. Pat. No. 5,461,134 (Leir et al.), U.S. Pat. No. 5,512,650 (Leir et al.), and U.S. Pat. No. 6,355,759 (Sherman et al.). Some polydiorganosiloxane diamines are commercially available, for example, from Shin Etsu Silicones of America, Inc. (Torrance, Calif.) and from Gelest Inc. (Morrisville, Pa.).

A polydiorganosiloxane diamine having a molecular weight greater than 2,000 g/mole or greater than 5,000 g/mole can be prepared using the methods described in U.S. Pat. No. 5,214,119 (Leir et al.), U.S. Pat. No. 5,461,134 (Leir et al.), and U.S. Pat. No. 5,512,650 (Leir et al.). One of the described methods involves combining under reaction conditions and under an inert atmosphere (a) an amine functional end blocker of the following formula

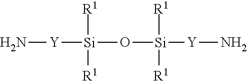

where Y and R¹ are the same as defined for Formulas (I) and (II); (b) sufficient cyclic siloxane to react with the amine functional end blocker to form a polydiorganosiloxane diamine having a molecular weight less than 2,000 g/mole; and (c) an anhydrous aminoalkyl silanolate catalyst of the following formula

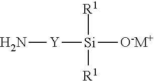

where Y and R¹ are the same as defined in Formulas (I) and (II) and M⁺ is a sodium ion, potassium ion, cesium ion, rubidium ion, or tetramethylammonium ion. The reaction is continued until all or substantially all of the amine functional end blocker is consumed and then additional cyclic siloxane is added to increase the molecular weight. The additional cyclic siloxane is often added slowly (e.g., drop wise). The reaction temperature is often conducted in the range of 80° C. to 90° C. with a reaction time of 5 to 7 hours. The resulting polydiorganosiloxane diamine can be of high purity (e.g., less than 2 weight percent, less than 1.5 weight percent, less than 1 weight percent, less than 0.5 weight percent, less than 0.1 weight percent, less than 0.05 weight percent, or less than 0.01 weight percent silanol impurities). Altering the ratio of the amine functional end blocker to the cyclic siloxane can be used to vary the molecular weight of the resulting polydiorganosiloxane diamine of Formula (II).

Another method of preparing the polydiorganosiloxane diamine of Formula (II) includes combining under reaction conditions and under an inert atmosphere (a) an amine functional end blocker of the following formula

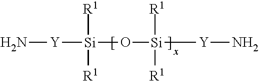

where R¹ and Y are the same as described for Formula (I) and where the subscript x is equal to an integer of 1 to 150; (b) sufficient cyclic siloxane to obtain a polydiorganosiloxane diamine having an average molecular weight greater than the average molecular weight of the amine functional end blocker; and (c) a catalyst selected from cesium hydroxide, cesium silanolate, rubidium silanolate, cesium polysiloxanolate, rubidium polysiloxanolate, and mixtures thereof. The reaction is continued until substantially all of the amine functional end blocker is consumed. This method is further described in U.S. Pat. No. 6,355,759 (Sherman et al.). This procedure can be used to prepare any molecular weight of the polydiorganosiloxane diamine.

Yet another method of preparing the polydiorganosiloxane diamine of Formula (II) is described in U.S. Pat. No. 6,531,620 (Brader et al.). In this method, a cyclic silazane is reacted with a siloxane material having hydroxy end groups as shown in the following reaction.

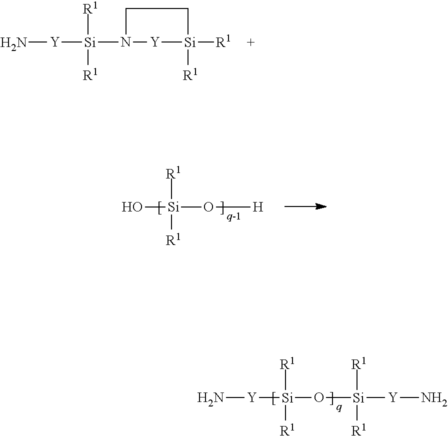

The groups R¹ and Y are same as described for Formula (II). The subscript q is an integer greater than 1.

Examples of polydiorganosiloxane diamines include, but are not limited to, polydimethylsiloxane diamine, polydiphenylsiloxane diamine, polytrifluoropropylmethylsiloxane diamine, polyphenylmethylsiloxane diamine, polydiethylsiloxane diamine, polydivinylsiloxane diamine, polyvinylmethylsiloxane diamine, poly(5-hexenyl)methylsiloxane diamine, and mixtures thereof.

The polydiorganosiloxane diamine component provides a means of adjusting the crosslink density of the resultant silicone polyurea block copolymer. In general, high molecular weight polydiorganosiloxane diamines provide copolymers of lower crosslink density whereas low molecular polydiorganosiloxane polyamines provide copolymers of higher crosslink density.

The polydiorganosiloxane diamine component reacts with a polyisocyanate to form the silicone polyurea block copolymers. Any polyisocyanate that can react with the above-described polydiorganosiloxane diamine can be used. The polyisocyanates are typically diisocyanates or triisocyanates. Examples of suitable diisocyanates include aromatic diisocyanates such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl) diphenylmethane, 4,4-diisocyanato-3,3′-dimethoxybiphenyl (o-dianisidine diisocyanate), 5-chloro-2,4-toluene diisocyanate, and 1-chloromethyl-2,4-diisocyanato benzene; aromatic-aliphatic diisocyanates such as m-xylylene diisocyanate and tetramethyl-m-xylylene diisocyanate; aliphatic diisocyanates such as 1,4-diisocyanatobutane, 1,6-diisocyanatohexane, 1,12-diisocyanatododecane, and 2-methyl-1,5-diisocyanatopentane; and cycloaliphatic diisocyanates such as methylenedicyclohexylene-4,4′-diisocyanate, 3-isocyanatomethyl-3,5,5-trimethylcyclohexyl isocyanate (isophorone diisocyanate), and cyclohexylene-1,4-diisocyanate. Examples of suitable triisocyanates include those produced from biurets, isocyanurates, and adducts. Examples of commercially available polyisocyanates include portions of the series of polyisocyanates available under the trade designations DESMODUR and MONDUR from Bayer and PAPI from Dow Plastics (Midland, Mich.).

The reaction mixture can include an optional organic polyamine. As used herein, the term “organic polyamine” refers to a polyamine that does not include a silicone group. Examples of useful organic polyamines include polyoxyalkylene diamines such as those commercially available under the trade designation D-230, D-400, D-2000, D-4000, ED-2001 and EDR-148 from Huntsman Corporation (Houston, Tex.), polyoxyalkylene triamines such as those commercially available under the trade designations T-403, T-3000 and T-5000 from Huntsman, alkylene diamines such as ethylene diamine, and various polyamines commercially available from DuPont (Wilmington, Del.) such as DYTEK A (2-methylpentamethylenediamine) and DYTEK EP (1,3-pentanediamine).

The optional organic polyamine provides a means of modifying the modulus of the copolymer. The concentration, type and molecular weight of the organic polyamine influence the modulus of the silicone polyurea block copolymer. Typically the polyamine has a molecular weight of no greater than about 300 g/mole.

The polyisocyanate is typically added in a stoichiometric amount based on the amount of polydiorganosiloxane diamine and any optional organic polyamines included in the reaction mixture to prepare the siloxane polyurea block copolymers.

Another useful class of silicone elastomeric polymers is oxamide-based polymers such as polydiorganosiloxane polyoxamide block copolymers. Examples of polydiorganosiloxane polyoxamide block copolymers are described, for example, in U.S. Patent Application Publication No. 2007/0148475 (Sherman et al.). The polydiorganosiloxane polyoxamide block copolymer contains at least two repeat units of Formula (III).

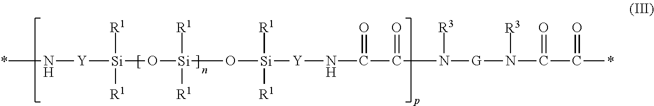

In Formula (III), each R¹ is independently an alkyl, haloalkyl, aralkyl, alkenyl, aryl, or aryl substituted with an alkyl, alkoxy, or halo. Each Y is independently an alkylene, aralkylene, or a combination thereof. Subscript n is independently an integer of 40 to 1500 and the subscript p is an integer of 1 to 10. Group G is a divalent group that is the residue unit that is equal to a diamine of formula R³HN-G-NHR³ minus the two —NHR³ groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine or the like). Each asterisk (*) indicates a site of attachment of the repeat unit to another group in the copolymer such as, for example, another repeat unit of Formula (III).

Suitable alkyl groups for R¹ in Formula (III) typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group having 1 to 10 carbon atoms and an aryl group having 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl where an alkylene is bonded to a phenyl group).

Often, at least 50 percent of the R¹ groups are usually methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo. In many embodiments, all of the R¹ groups are an alkyl.

Each Y in Formula (III) is independently an alkylene, arylene, aralkylene, or combinations thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group having 6 to 12 carbon atoms bonded to an alkylene group having 1 to 10 carbon atoms. In some exemplary aralkylene groups, the arylene portion is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene group. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

Each subscript n in Formula (III) is independently an integer of 40 to 1500. For example, subscript n can be an integer up to 1000, up to 500, up to 400, up to 300, up to 200, up to 100, up to 80, or up to 60. The value of n is often at least 40, at least 45, at least 50, or at least 55. For example, subscript n can be in the range of 40 to 1000, 40 to 500, 50 to 500, 50 to 400, 50 to 300, 50 to 200, 50 to 100, 50 to 80, or 50 to 60.

The subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1 to 4.

Group G in Formula (III) is a residual unit that is equal to a diamine compound of formula R³HN-G-NHR³ minus the two amino groups (i.e., —NHR³ groups). Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine). The diamine can have primary or secondary amino groups. In most embodiments, R³ is hydrogen or an alkyl. In many embodiments, both of the amino groups of the diamine are primary amino groups (i.e., both R³ groups are hydrogen) and the diamine is of formula H₂N-G-NH₂.

In some embodiments, G is an alkylene, heteroalkylene, polydiorganosiloxane, arylene, aralkylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof. Suitable polydiorganosiloxanes include the polydiorganosiloxane diamines of Formula (II), which are described above, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. As used herein with reference to group G, “a combination thereof” refers to a combination of two or more groups selected from an alkylene, heteroalkylene, polydiorganosiloxane, arylene, and aralkylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

The polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

The polydiorganosiloxane polyoxamide is a linear, block copolymer and is an elastomeric material. Unlike many of the known polydiorganosiloxane polyamides that are generally formulated as brittle solids or hard plastics, the polydiorganosiloxane polyoxamides can be formulated to include greater than 50 weight percent polydiorganosiloxane segments based on the weight of the copolymer. The weight percent of the diorganosiloxane in the polydiorganosiloxane polyoxamides can be increased by using higher molecular weight polydiorganosiloxanes segments to provide greater than 60 weight percent, greater than 70 weight percent, greater than 80 weight percent, greater than 90 weight percent, greater than 95 weight percent, or greater than 98 weight percent of the polydiorganosiloxane segments in the polydiorganosiloxane polyoxamides. Higher amounts of the polydiorganosiloxane can be used to prepare elastomeric materials with lower modulus while maintaining reasonable strength.

The polydiorganosiloxane polyoxamide copolymers have many of the desirable features of polysiloxanes such as low glass transition temperatures, thermal and oxidative stability, resistance to ultraviolet radiation, low surface energy and hydrophobicity, and high permeability to many gases. Additionally, the copolymers exhibit good to excellent mechanical strength.

Another useful class of silicone elastomeric polymers is amide-based silicone copolymers. Such polymers are similar to the urea-based polymers, containing amide linkages (—N(D)-C(O)—) instead of urea linkages (—N(D)-C(O)—N(D)-), where C(O) represents a carbonyl group and D is the same as defined above for Formula (I). The group D is often hydrogen or alkyl.

The amide-based copolymers may be prepared in a variety of different ways. Starting from the polydiorganosiloxane diamine described above in Formula (II), the amide-based copolymer can be prepared by reaction with a poly-carboxylic acid or a poly-carboxylic acid derivative such as, for example di-esters. In some embodiments, an amide-based silicone elastomer is prepared by the reaction of a polydiorganosiloxane diamine and di-methyl salicylate of adipic acid.

An alternative reaction pathway to amide-based silicone elastomers utilizes a silicone di-carboxylic acid derivative such as a carboxylic acid ester. Silicone carboxylic acid esters can be prepared through the hydrosilation reaction of a silicone hydride (i.e. a silicone terminated with a silicon-hydride (Si—H) bonds) and an ethylenically unsaturated ester. For example a silicone di-hydride can be reacted with an ethylenically unsaturated ester such as, for example, CH₂═CH—(CH₂)ᵥ—C(O)—OR, where C(O) represents a carbonyl group and v is an integer up to 15, and R is an alkyl, aryl or substituted aryl group, to yield a silicone chain capped with —Si—(CH₂)ᵥ₊₂—C(O)—OR. The —C(O)—OR group is a carboxylic acid derivative which can be reacted with a silicone diamine, a polyamine or a combination thereof. Suitable silicone diamines and polyamines have been discussed above and include aliphatic, aromatic or oligomeric diamines (such as ethylene diamine, phenylene diamine, xylylene diamine, polyoxalkylene diamines, etc).

Another useful class of silicone elastomeric polymers is urethane-based silicone polymers such as silicone polyurea-urethane block copolymers. Silicone polyurea-urethane block copolymers include the reaction product of a polydiorganosiloxane diamine (also referred to as silicone diamine), a diisocyanate, and an organic polyol. Such materials are structurally very similar to the structure of Formula (I) except that the —N(D)-B—N(D)- links are replaced by —O—B—O— links. Examples are such polymers are further described in U.S. Pat. No. 5,214,119 (Leir et al.).

These urethane-based silicone polymers are prepared in the same manner as the urea-based silicone polymers except that an organic polyol is substituted for an organic polyamine. Typically, since the reaction between an alcohol and an isocyanate is slower than the reaction between an amine and an isocyanate, a catalyst is used. The catalyst is often a tin-containing compound.

The silicone elastomeric polymers can be prepared by solvent-based processes, solventless processes or a combination thereof. Useful solvent-based processes are described, for example, in U.S. Pat. No. 5,214,119 (Leir et al.). Useful methods of manufacturing silicone elastomeric polymers are also described in U.S. Pat. No. 5,512,650 (Leir et al.), and U.S. Pat. No. 5,461,134 (Leir et al.), U.S. Pat. No. 6,664,359 (Kangas), U.S. Pat. No. 6,846,893 (Sherman et al.), and U.S. Pat. No. 6,407,195 (Sherman et al.).

If desired, the physically cross-linked elastomers may additionally be covalently cross-linked. For example, the physically cross-linked elastomers may be subjected to ultraviolet (UV) curing of terminal or pendant (meth)acrylate groups, moisture curing groups (for example, silane functionality), or exposed to high energy such as electron beam and the like. The silicone polyurea and silicone polyoxamides materials may be prepared according to the general procedures outlined, respectively, in: U.S. Pat. Nos. 7,501,184 and 8,765,881 (silicone polyoxamide elastomer); U.S. Pat. No. 7,371,464 (silicone polyoxamide pressure sensitive adhesive); and U.S. Pat. Nos. 5,214,114 and 5,461,134 (silicone polyurea).

In one embodiment, the silicone-based assembly layer includes a covalently cross-linked silicone elastomers. Suitable covalently cross-linked silicones includes those derived from silicone elastomer forming reagents that undergo for example condensation curing, addition curing, and thiol-ene type reaction. Examples of suitable covalently cross-linked silicones include those that are derived from vinyl functional precursors and silicon hydride precursors. In one embodiment, the covalently cross-linked silicones are polydimethylsiloxane based. In another embodiment, some phenyl substitution can be used to replace the methyl groups, such as, for example, to adjust the refractive index of the resulting layer. Electron-beam cross-linked silicones derived from silicone fluids, such as those described in U.S. Pat. No. 8,541,481 (Determan et al.) may also be used, provided their properties meet the general design criteria outlined in this specification. More traditionally synthesized silicone pressure sensitive adhesives, such as those prepared by addition curing or condensation curing methods can also be used, provided their physical properties are tailored for low modulus and high yield under moderate stress as outlined in this specification.

Examples of commercially available suitable vinyl functional silicones include vinyl terminated silicones of relatively high molecular weight. The use of high molecular weight vinyl terminated silicones results in a high molecular weight between cross-links and therefore a relatively low modulus of the cross-linked silicone. Examples of commercially available suitable multifunctional hydride cross-linkers include SYL-OFF 7048, SYL-OFF 7488, and SYL-OFF 7678, available from Dow Corning. The ratio of hydride cross-linker to vinyl silicone used to form the silicone network is such that complete or nearly complete incorporation of all of the vinyl functional silicone precursor into the silicone network is achieved, such that the resultant network is highly elastic. Lower molecular weight vinyl terminated silicones may also be used if a portion of the multifunctional hydride cross-linker is replaced with hydride terminated silicones. The hydride-terminated silicone acts as a chain extender, rather than a cross-linker, thereby reducing the crosslink density of the assembly layer. By adjusting the molar ratio of vinyl-terminated silicone to hydride-terminated silicone, the cross-link density and rheology of the assembly layer can be adjusted. An examples of a hydride terminated silicone includes, but is not limited to, DMS-H11 available from Gelest.

A Pt based catalyst is also necessary in the formulation of covalently cross-linked silicone elastomer forming reagent mixtures in addition cure systems. The Pt based catalyst catalyzes the reaction between the vinyl groups on the base silicone and the hydride groups on the cross-linker. An example of a commercially available Pt catalyst includes, but is not limited to, SIP 6831.2, a platinum divinyltetramethyldisiloxane complex in xylene, available from Gelest. Typical Pt catalyst levels are between about 50 and about 150 ppm Pt.

Optionally, inhibitors such as 1-Ethynylcyclohexanol, available from Alfa Aesar, or diallyl maleate, available from Momentive, can be included in the adhesive to increase bath life. The components of the silicone-based assembly layer can be blended and diluted further with solvents such as heptane and toluene to obtain a reasonable viscosity for coating.

While silicone elastomers are typically designed to provide high elongation under minimum load, they may not have sufficient adhesion to desired substrates to pass the severe durability requirements needed in flexible display assembly applications. Thus, a tackifier like MQ resin is included in the composition to tune the level of adhesion and enhance the durability of the device in which the silicone-based assembly layer is used. In general, lower levels of adhesion for the assembly layer may be acceptable and tolerance for high shear loading over a broad temperature range (−25 C to 100° C.) is most critical. High levels of MQ resin (i.e., about 55 weight %) push the glass transition and modulus up. Thus, in some embodiments, it is may be advantageous to use lower levels of MQ resin. In some embodiments, the silicone-based assembly layer includes between about 5 and about 50 weight % MQ resin, and particularly between about 10 and about 50 weight % MQ resin, provide better balance among adhesion, shear modulus, dynamic shear loading, and durability of the multi-layer flexible display device that includes the silicone-based assembly layer.

Useful MQ tackifying resins include, for example, MQ silicone resins, MQD silicone resins, and MQT silicone resins. These tackifying resins often have a number average molecular weight of about 100 to about 50,000, or about 500 to about 20,000 and generally have methyl substituents. The MQ silicone resins include both non-functional and functional resins, the functional resins having one or more functionalities including, for example, silicon-bonded hydrogen, silicon-bonded alkenyl, and silanol.

MQ silicone resins are copolymeric silicone resins having R′3SiO_{1/2} units (M units) and SiO_{4/2} units (Q units). Such resins are described in, for example, Encyclopedia of Polymer Science and Engineering, vol. 15, John Wiley & Sons, New York, (1989), pp. 265 to 270, and U.S. Pat. No. 2,676,182 (Daudt at al.); U.S. Pat. No. 3,627,851 (Brady); U.S. Pat. No. 3,772,247 (Flannigan); and U.S. Pat. No. 5,248,739 (Schmidt et al.). MQ silicone resins having functional groups are described in U.S. Pat. No. 4,774,310 (Butler), which describes silyl hydride groups, U.S. Pat. No. 5,262,558 (Kobayashi et al.), which describes vinyl and trifluoropropyl groups, and U.S. Pat. No. 4,707,531 (Shirahata), which describes silyl hydride and vinyl groups. The above-described resins are generally prepared in solvent. Dried or solventless MQ silicone resins are prepared as described in U.S. Pat. No. 5,319,040 (Wengrovius et al.); U.S. Pat. No. 5,302,685 (Tsumura); and U.S. Pat. No. 4,935,484 (Wolfgruber).

MQD silicone resins are terpolymers having R′₃SiO_{1/2} units (M units), SiO_{4/2} units (Q units), and R′₂SiO_{2/2} units (D units) as described, e.g., in U.S. Pat. No. 5,110,890 (Butler).

MQT silicone resins are terpolymers having R₃SiO_{1/2} units (M units), SiO_{4/2} units (Q units), and RSiO_{3/2} units (T units) (MQT resins).

The MQ silicone resins are often supplied in an organic solvent. Examples of commercially available suitable MQ resins (also called a tackifier) include 2-7066 supplied by Dow Corning and SR545 supplied by Momentive, available as 60% solutions in toluene. In one embodiment, the MQ silicone resin can also include blends of two or more silicone resins.

Just as the silicone elastomeric polymers may be made from a variety of processes, the silicone-based assembly layer may also be prepared by a variety of processes. For example, the assembly layer may be prepared in a solvent-based process, a solventless process or a combination thereof.

In solvent-based processes, the MQ resin can be introduced before, during or after the reactants used to form the polymer, such as polyamines and polyisocyanates, have been introduced into the reaction mixture. The reaction may be carried out in a solvent or a mixture of solvents. The solvents are preferably nonreactive with the reactants. The starting materials and final products preferably remain completely miscible in the solvents during and after the completion of the polymerization. These reactions can be conducted at room temperature or up to the boiling point of the reaction solvent. The reaction is generally carried out at ambient temperature up to 50° C. Additionally, the elastomeric polymer may be prepared in a solvent mixture with the MQ resin added later, after the polymer has been formed.

In substantially solventless processes, the reactants used to form the polymer and the MQ resin are mixed in a reactor and the reactants are allowed to react to form the silicone elastomeric polymer, and thus form the adhesive composition. Additionally, the silicone elastomeric polymer can be made in a solventless process, in for example a mixer or extruder, and either be isolated or simply transferred to an extruder and mixed with MQ resin.

One useful method that includes a combination of a solvent-based process and a solventless process includes preparing the silicone elastomeric polymer using a solventless process and then mixing the silicone elastomeric polymer with the MQ resin solution in a solvent.

The assembly layer composition can be coated onto a release liner, coated directly onto the carrier film, co-extruded with a flexible substrate film, or formed as a separate layer (e.g., coated onto a release liner) and then laminated to the flexible substrate. In some embodiments, the assembly layer is disposed between two release liners for subsequent lamination to the flexible substrate.

The disclosed compositions or precursors may be coated by any variety of coating techniques known to those of skill in the art, such as roll coating, spray coating, knife coating, die coating, and the like. The silicone adhesive solutions can be coated onto a liner, such as SILFLU MD07 fluorosilicone-coated PET liner (Siliconature S.p.A., Italy) and heated to remove any solvent and to cure the silicone adhesive in order to prepare a transfer adhesive. Alternatively, the silicone adhesive can be coated directly onto one of the layers of the flexible display and heated to dry and/or cure the silicone adhesive. In the case of vinyl functional silicones cross-linked with hydride functional cross-linkers using a platinum catalyst, the adhesive mixtures can be dried and cured at temperatures between about 100° C. and 120° C. for one to two minutes. In the case of silicone PSAs based on silicone polyurea or silicone polyoxamide elastomers, heating is only needed for drying of any solvent carriers. The drying can be carried out at temperatures between about 60° C. and 120° C.

The present invention also provides laminates including the silicone-based assembly layer. A laminate is defined as a multi-layer composite of at least one assembly layer sandwiched between two flexible substrate layers or multiples thereof. For example the composite can be a 3 layer composite of substrate/assembly layer/substrate; a 5-layer composite of substrate/assembly layer/substrate/assembly layer/substrate, and so on. The thickness, mechanical, electrical (such as dielectric constant), and optical properties of each of the flexible assembly layers in such multi-layer stack may be the same but they can also be different in order to better fit the design and performance characteristics of the final flexible device assembly. The laminates have at least one of the following properties: optical transmissivity over a useful lifetime of the article in which it is used, the ability to maintain a sufficient bond strength between layers of the article in which it is used, resistance or avoidance of delamination, and resistance to bubbling over a useful lifetime. The resistance to bubble formation and retention of optical transmissivity can be evaluated using accelerated aging tests. In an accelerated aging test, the silicone-based assembly layer is positioned between two substrates. The resulting laminate is then exposed to elevated temperatures often combined with elevated humidity for a period of time. Even after exposure to elevated temperature and humidity, the laminate, including the silicone-based assembly layer, will retain optical clarity. For example, the silicone-based assembly layer and laminate remain optically clear after aging at 70° C. and 90% relative humidity for approximately 72 hours and subsequently cooling to room temperature. After aging, the average transmission of the adhesive between 400 nanometers (nm) and 700 nm is greater than about 90% and the haze is less than about 5% and particularly less than about 2%.

In use, the silicone-based assembly layer will resist fatigue over thousands of folding cycles over a broad temperature range from well below freezing (i.e., −30 degrees C., −20 degrees C., or −10 degrees C.) to about 70, 85 or even 90° C. In addition, because the display incorporating the silicone-based assembly layer may be sitting static in the folded state for hours, the silicone-based assembly layer has minimal to no creep, preventing significant deformation of the display, deformation which may be only partially recoverable, if at all. This permanent deformation of the silicone-based assembly layer or the panel itself could lead to optical distortions or Mura, which is not acceptable in the display industry. Thus, the silicone-based assembly layer is able to withstand considerable flexural stress induced by folding a display device as well as tolerating high temperature, high humidity (HTHH) testing conditions. Most importantly, the silicone-based assembly layer has exceptionally low storage modulus and high elongation over a broad temperature range (including well below freezing; thus, low glass transition temperatures are preferred) and are cross-linked to produce an elastomer with little or no creep under static load.

During a folding or unfolding event, it is expected that the silicone-based assembly layer will undergo significant deformation and cause stresses. The forces resistant to these stresses will be in part determined by the modulus and thickness of the layers of the folding display, including the silicone-based assembly layer. To ensure a low resistance to folding as well as adequate performance, generation of minimal stress and good dissipation of the stresses involved in a bending event, the silicone-based assembly layer has a sufficiently low storage or elastic modulus, often characterized as shear storage modulus (G′). To further ensure that this behavior remains consistent over the expected use temperature range of such devices, there is minimal change in G′ over a broad and relevant temperature range. In one embodiment, the relevant temperature range is between about −30° C. to about 90° C. In one embodiment, the shear modulus is less than about 2 MPa, particularly less than about 1 MPa, more particularly less than about 0.5 MPa, and most particularly less than about 0.3 MPa over the entire relevant temperature range. Therefore, it is preferred to position the glass transition temperature (Tg), the temperature at which the material transitions to a glassy state, with a corresponding change in G′ to a value typically greater than about 10⁷ Pa, outside and below this relevant operating range. In one embodiment, the Tg of the silicone-based assembly layer in a flexible display is less than about 10° C., particularly less than about −10° C., and more particularly less than about −30° C. As used herein, the term “glass transition temperature” or “Tg′” refers to the temperature at which a polymeric material transitions from a glassy state (e.g., brittleness, stiffness, and rigidity) to a rubbery state (e.g., flexible and elastomeric). The Tg can be determined, for example, using a technique such as Dynamic Mechanical Analysis (DMA). In one embodiment, the Tg of the silicone-based assembly layer in a flexible display is less than about 10° C., particularly less than about −10° C., and more particularly less than about −30° C.

The assembly layer is typically coated at a dry thickness of less than about 300 microns, particularly less than about 50 microns, particularly less than about 20 microns, more particularly less than about 10 microns, and most particularly less than about 5 microns. The thickness of the assembly layer may be optimized according to the position in the flexible display device. Reducing the thickness of the assembly layer may be preferred to decrease the overall thickness of the device as well as to minimize buckling, creep, or delamination failure of the composite structure.

The ability of the silicone-based assembly layer to absorb the flexural stress and comply with the radically changing geometry of a bend or fold can be characterized by the ability of such a material to undergo high amounts of strain or elongation under relevant applied stresses. This compliant behavior can be probed through a number of methods, including a conventional tensile elongation test as well as a shear creep test. In one embodiment, in a shear creep test, the silicone-based assembly layer exhibits a shear creep compliance (J) of at least about 6×10⁻⁶ 1/Pa, particularly at least about 20×10⁻⁶ 1/Pa, about 50×10⁻⁶ 1/Pa, and more particularly at least about 90×10⁻⁶ 1/Pa under an applied shear stress of between from about 5 kPa to about 500 kPa, particularly between about 20 kPa to about 300 kPa, and more particularly between about 50 kPa to about 200 kPa. The test is normally conducted at room temperature but could also be conducted at any temperature relevant to the use of the flexible device.

The silicone-based assembly layer also exhibits relatively low creep to avoid lasting deformations in the multilayer composite of a display following repeated folding or bending events. Material creep may be measured through a simple creep experiment in which a constant shear stress is applied to a material for a given amount of time. Once the stress is removed, the recovery of the induced strain is observed. In one embodiment, the shear strain recovery within 1 minute after removing the applied stress (at at least one point of applied shear stress within the range of about 5 kPa to about 500 kPa) at room temperature is at least about 50%, particularly at least about 60%, about 70% and about 80%, and more particularly at least about 90% of the peak strain observed at the application of the shear stress. The test is normally conducted at room temperature but could also be conducted at any temperature relevant to the use of the flexible device.

Additionally, the ability of the silicone-based assembly layer to generate minimal stress and dissipate stress during a fold or bending event is critical to the ability of the silicone-based assembly layer to avoid interlayer failure as well as its ability to protect the more fragile components of the flexible display assembly. Stress generation and dissipation may be measured using a traditional stress relaxation test in which a material is forced to and then held at a relevant shear strain amount. The amount of shear stress is then observed over time as the material is held at this target strain. In one embodiment, following about 500% shear strain, particularly about 600%, about 700%, and about 800%, and more particularly about 900% strain, the amount of residual stress (measured shear stress divided by peak shear stress) observed after 5 minutes is less than about 50%, particularly less than about 40%, about 30%, and about 20%, and more particularly less than about 10% of the peak stress. The test is normally conducted at room temperature but could also be conducted at any temperature relevant to the use of the flexible device.

As an assembly layer, the silicone-based assembly layer must adhere sufficiently well to the adjacent layers within the display assembly to prevent delamination of the layers during the use of the device that includes repeated bending and folding actions. While the exact layers of the composite will be device specific, adhesion to a standard substrate such as PET may be used to gauge the general adhesive performance of the assembly layer in a traditional 180 degree peel test mode. The adhesive may also need sufficiently high cohesive strength, which can be measured, for example, as a laminate of the assembly layer material between two PET substrates in a traditional T-peel mode.

When the silicone-based assembly layer is placed between two substrates to form a laminate and the laminate is folded or bent and held at a relevant radius of curvature, the laminate does not buckle or delaminate between all use temperatures (−30° C. to 90° C.), an event that would represent a material failure in a flexible display device. In one embodiment, a multilayer laminate containing the silicone-based assembly layer does not exhibit failure when placed within a channel forcing a radius of curvature of less than about 200 mm, less than about 100 mm, less than about 50 mm, particularly less than about 20 mm, about 15 mm, about 10 mm, and about 5 mm, and more particularly less than about 2 mm over a period of about 24 hours. Furthermore, when removed from the channel and allowed to return from the bent orientation to its previously flat orientation, a laminate including the silicone-based assembly layer of the present invention does not exhibit lasting deformation and rather rapidly returns to a flat or nearly flat orientation. In one embodiment, when held for 24 hours and then removed from the channel that holds the laminate with a radius of curvature of particularly less than about 50 mm, particularly less than about 20 mm, about 15 mm, about 10 mm, and about 5 mm, and more particularly less than about 3 mm, the composite returns to a nearly flat orientation where the final angle between the laminate, the laminate bend point and the return surface is less than about 50 degrees, more particularly less than about 40 degrees, about 30 degrees, and about 20 degrees, and more particularly less than about 10 degrees within 1 hour after the removal of the laminate from the channel. In other words, the included angle between the flat parts of the folded laminate goes from 0 degrees in the channel to an angle of at least about 130 degrees, particularly more than about 140 degrees, about 150 degrees, and about 160 degrees, and more particularly more than about 170 degrees within 1 hour after removal of the laminate from the channel. This return is preferably obtained under normal usage conditions, including after exposure to durability testing conditions.

In addition to the static fold testing behavior described above, the laminate including first and second substrates bonded with the silicone-based assembly layer does not exhibit failures such as buckling or delamination during dynamic folding simulation tests. In one embodiment, the laminate does not exhibit a failure event between all use temperatures (−30° C. to 90° C.) over a dynamic folding test in free bend mode (i.e. no mandrel used) of greater than about 10,000 cycles, particularly greater than about 20,000 cycles, about 40,000 cycles, about 60,000 cycles, and about 80,000 cycles, and more particularly greater than about 100,000 cycles of folding with a radius of curvature of less than about 50 mm, particularly less than about 20 mm, about 15 mm, about 10 mm, and about 5 mm, and more particularly less than about 3 mm.

To form a flexible laminate, a first substrate is adhered to a second substrate by positioning the assembly layer of the present invention between the first substrate and the second substrate. Additional layers may also be included to make a multi-layer stack. Pressure and/or heat is then applied to form the flexible laminate.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Test Methods

### Optical Properties

Optical measurements were made using an UltrascanPro Spectrophotometer (HunterLab, Reston, Va.) in transmission mode. Optically clear adhesive (OCA) samples 2 mil thick coated between release-coated carrier liners (2 mil SILFLU S 50M 1R82001 and 2 mil SILFLU S 50M 1R88002luorosilicone coated PET liner, Siliconature S.p.A., Italy) were cut to approximately 5 cm width by 10 cm length. One of the carrier liners was removed and the sample was laminated to a clear piece of 1 mm thick LCD glass. The other liner was then removed and the sample was placed in the UltrascanPro Spectrophotometer (HunterLab) to measure transmission, haze and b* though the OCA/glass assembly. The glass background was also measured allowing for correction of the transmission, haze and color for the assembly and thus the report values reflect the OCA properties only. Additional samples (50 micron thick Skyrol SH81 from SKC Korea/OCA/glass slide) were prepared and aged using one of three methods. The first method was to put the sample in a chamber for exposure to a temperature cycle that consisted of ramping from room temperature to 85° C. and 25% relative humidity in one hour, holding for six hours, and returning to room temperature over one hour. The second method was to age samples at 85° C. for 250, 500, and 1000 hours. The third method was to expose the samples to 85° C. and 85% relative humidity for 250, 500 and 1000 hours. The fourth method was to expose the samples to 65° C. and 90% relative humidity for 250, 500 and 1000 hours. After samples were removed from the humidity chamber and allowed to cool to room temperature, the percent transmission, percent haze and b* measurements were repeated.

### Rheology

Rheometry was used to probe the shear modulus as a function of temperature as well as to determine the glass transition temperature (T_{g}) of the material. An 8 mm diameter by about 1 mm thick disk of the OCA was placed between the probes of an Ares 2000 parallel plate rheometer (TA Instruments, New Castle, Del.). A temperature scan was performed ramping from −75° C. to 150° C. at 3° C. per minute. During this ramp, the sample was oscillated at a frequency of 1 Hz and a strain of approximately 0.4%. The shear storage modulus (G′) was recorded at selected key temperatures. The T_{g} of the material was also determined as the peak in the Tan Delta vs. temperature profile.

### Creep Test

The OCA samples were subjected to a creep test by placing a 8 mm diameter by 0.25 mm thick disk in a DHR parallel plate rheometer and applying a shear stress of 95 kPa for 5 seconds at which time the applied stress was removed and the sample was allowed to recover in the fixtures for 60 seconds. The peak shear strain at 5 seconds and the amount of strain recovery after 60 seconds were recorded. The shear creep compliance, J, at any time following the application of the stress is defined as the ratio of the shear strain at that time divided by the applied stress. To ensure sufficient compliance within the OCA, it is preferred that the peak shear strain after applying the load in the test described above is greater than about 200%. Furthermore, to minimize material creep within the flexible assembly, it is preferred that the material recover greater that about 50% strain 60 seconds after the applied stress is removed. The percent recoverable strain is defined as ((S₁−S₂)/S₁)*100 where S₁ is the shear strain recorded at the peak at 5 seconds after applying the stress and S₂ is the shear strain measured at 60 seconds after the applied stress is removed.

### Stress Relaxation Test

OCA samples were subjected to a stress relaxation test by placing a 8 mm diameter by 0.25 mm thick disk in a DHR parallel plate rheometer (TA Instruments, New Castle, Del.) and applying a shear strain of 900%. The resulting peak stress from this deformation was recorded as well as the stress decay over a 5 minute period. Stress relaxation was calculated by the following equation: (1−(S_{f}−Sₚ))*100% where Sₚ and S_{f} are the shear strain recorded at the peak and final (5 minute) points.

### T-Peel Testing

An OCA layer of approximately 100 micron thick was laminated between two layers of primed polyethylene terephthalate (PET) that were 75 micron in thickness. From this laminate, strips of 1 inch width by 6 inch length were cut for testing. At one end of each test strip, the PET was free of OCA to facilitate tensile testing. The free ends of each PET liner were placed in the tensile grips of an Instron device (Instron, Norwood, Mass.). The laminated strip was then peeled at a rate of 50 mm/min while measuring the force in grams of the peel adhesion. Three peel tests were performed for each Example and the resulting peel force averaged. The failure mode was recorded, with only cohesive failure of the adhesive providing a good measure of the cohesive strength of the material.

### Shear Testing:

An OCA layer approximately 100 micron thick was laminated between two layers of primed PET that are 75 micron in thickness and about 2 cm wide. An adhesive film overlap of 2 cm width by 2 cm length was used and the free ends of each film strip were placed in the tensile grips of an Instron device. The construction was then sheared at a rate of 30 mm/min while measuring the force in grams. Three shear tests were performed for each example and the resulting shear force averaged.

### Static Folding Test

The liners of a transfer tape made with 2 mil thick OCA were removed and the OCA was laminated between 1.4 mil thick sheets of polyimide and then cut to a width of 1″ and a length of 5″. The sample was then bent around a 3 mm radius of curvature and held in that position for 24 hours. After 24 hours the sample was released and allowed to recover for 24 hours before its final angle (relative to the plane) was recorded. The test was carried out at −20° C., RT, 65° C./90% RH and 85° C./85% RH.

### Dynamic Folding Test

A 2 mil thick OCA transfer tape was laminated between 1.7 mil sheets of polyimide and then cut to a 5″ length by 1″ width. The sample was mounted in a dynamic folding device with two folding tables that rotate from 180 degrees (i.e. sample is not bent) to 0 degrees (i.e. sample is now folded) for thousands of cycles. The test rate is about 20 cycles/minute. The bend radius of 3 mm is determined by the gap between the two rigid plates in the closed state (0 degrees). No mandrel was used to guide the curvature, i.e. a free bend format was used. Folding was done at room temperature.

### Polymer Formulation and Test Results

### Physically Cross-Linked Silicone Polyurea and Silicone Polyoxamide Optically Clear Adhesives

Silicone polyurea and silicone polyoxamide polymers were prepared according to the general procedures outlined in respectively US patents: silicone polyoxamide elastomer: U.S. Pat. No. 7,501,184, U.S. Pat. No. 8,765,881; silicone polyoxamide pressure sensitive adhesive (PSA): U.S. Pat. No. 7,371,464; and silicone polyurethane: U.S. Pat. No. 5,214,114, U.S. Pat. No. 5,461,134 (these include PSAs). The materials used are listed in Table 1 with the silicone polyurea and silicone polyoxamide formulations presented in Table 2.

TABLE 1
Materials

| Trade name or | | |
|---|---|---|
| designation | Description | Supplier |
| SPU or SPOx | Various Mw silicone polyureas | 3M (St. Paul, MN) |
| | or silicone polyoxamides | |
| 2-7066 | MQ resin | Dow Corning |
| | | (Midland, MI) |

TABLE 2
Silicone polyoxamide and silicone polyurea OCA formulations

| Example | Resin | % MQ |
|---|---|---|
| 1 | 15K SPOx | 50 |
| 2 | 50K SPOx | 50 |
| 3 | 33K SPU | 35 |
| 4 | 33K SPU | 40 |
| 5 | 33K SPU | 45 |
| 6 | 33K SPU | 50 |
| 7 | 50K SPU | 35 |
| 8 | 50K SPU | 40 |
| 9 | 50K SPU | 45 |
| 10 | 50K SPU | 50 |

The shear storage modulus at −25° C., −20° C., 0° C., 25° C., 60° C., 65° C. and the T_{g} of the silicone polyoxamide and silicone polyurea OCAs were determined by the methods described in the rheology test method section. The storage modulus results and T_{g} are presented in Table 3. It is preferred that the shear storage modulus G of each of these samples is less than 2 MPa, even at −20° C. Creep testing was conducted as described above and the results are presented in Table 4. The results of 180° Peel and T-Peel testing of silicone polyoxamide and silicone polyurea OCAs are also presented in Table 4. It is preferred that even when stressed at 90 kPa, the shear strain is more than 300% and when stressed at 95 kPa followed by removal of the applied stress, the recovery is more than 50% of the original strain. Optical properties are listed in Table 5.

TABLE 3
Rheology

| | Shear Storage Modulus (MPa) | | | | | | Tg from |
|---|---|---|---|---|---|---|---|
| Example | −25° C. | −20° C. | 0° C. | 25° C. | 60° C. | 65° C. | Tan(Delta) |
| 1 | 1.924 | 1.591 | 0.789 | 0.406 | 0.213 | 0.191 | −8.26 |
| 2 | 0.809 | 0.809 | 0.216 | 0.095 | 0.047 | 0.043 | −9.17 |
| 3 | 0.053 | 0.052 | 0.051 | 0.052 | 0.052 | 0.052 | −73.97 |
| 4 | 0.055 | 0.051 | 0.043 | 0.040 | 0.038 | 0.037 | −62.32 |
| 5 | 0.099 | 0.082 | 0.052 | 0.040 | 0.034 | 0.033 | −43.13 |
| 6 | 0.160 | 0.131 | 0.072 | 0.051 | 0.042 | 0.041 | −38.05 |
| 7 | 0.032 | 0.032 | 0.031 | 0.032 | 0.033 | 0.033 | −73.75 |
| 8 | 0.045 | 0.042 | 0.036 | 0.035 | 0.035 | 0.035 | −63.80 |
| 9 | 0.058 | 0.048 | 0.030 | 0.023 | 0.020 | 0.020 | −43.64 |
| 10 | 0.325 | 0.325 | 0.136 | 0.093 | 0.073 | 0.071 | −33.96 |

TABLE 4
Creep, Shear Strain and Peels

| | Creep | | Shear | | | | |
|---|---|---|---|---|---|---|---|
| | Testing | | Strain | 180° | 180° | T-Peel | |
| | at 95 kPa | | (between | Peel on | Peel - | between | T-Peel |
| | Max | | PET, RT | glass | Failure | PET | Failure |
| Example | Strain | Recovery | at 90 kPa) | (g/in) | mode | (g/in) | Mode |
| 1 | 38.32 | 100.00% | 373.51 | 1802.1 | 2-bond | 1175.64 | Adhesive |
| 2 | 181.32 | 98.19% | 389.33 | 1003 | 2-bond | 1647.38 | Adhesive |
| 3 | 149.86 | 96.49% | 655.58 | 1358 | Adhesive | 672.14 | Adhesive |
| 4 | 161.97 | 98.51% | 785.75 | 2690 | Adhesive | 1006.85 | Adhesive |
| 5 | 171.72 | 98.66% | 608.66 | 3190 | Cohesive | 1138.42 | Adhesive |
| 6 | 183.57 | 98.43% | 588.56 | 3242 | Cohesive | 1158.99 | Adhesive |
| 7 | 376.43 | 65.99% | 512.50 | 1222 | Adhesive | 795.17 | Adhesive |
| 8 | 231.10 | 99.11% | 786.96 | 1997 | Adhesive | 1063.63 | Adhesive |
| 9 | 237.73 | 98.12% | 705.20 | 2603 | Adhesive | 1260.46 | Adhesive |
| 10 | 155.05 | 97.23% | 336.98 | 1958 | 2-bond | 1482.36 | Adhesive |

TABLE 5
Optical Properties

| | | | Example | | | | | | |
|---|---|---|---|---|---|---|---|---|---|
| | | | 1 | 2 | 4 | 5 | 6 | 8 | 10 |
| STS | 0 hr | b* | 0.16 | 0.2 | 0.15 | 0.16 | 0.16 | 0.15 | 0.16 |
| | | Haze | 0.5 | 0.6 | 0.10 | 1.1* | 0.6 | 0.20 | 0.4 |
| | | % T | 92.8 | 92.7 | 92.90 | 92.7 | 93 | 92.90 | 93 |
| | STS | b* | 0.17 | 0.21 | 0.17 | 0.18 | 0.15 | 0.15 | 0.16 |
| | | Haze | 0.9 | 2.8 | 0.50 | 0.3 | 0.6 | 0.20 | 0.4 |
| | | % T | 92.9 | 92.1 | 92.80 | 93 | 93 | 93.00 | 93 |
| 85° C. | 0 hr | b* | 0.17 | 0.19 | 0.16 | 0.18 | 0.15 | 0.14 | 0.16 |
| Dry | | Haze | 0.8 | 0.6 | 0.20 | 1* | 1* | 0.10 | 0.5 |
| | | % T | 92.9 | 92.9 | 92.90 | 92.9 | 92.9 | 92.90 | 93 |
| | 250 hr | b* | 0.18 | 0.19 | 0.17 | 0.17 | −1.17 | 0.18 | 0.17 |
| | | Haze | 0.6 | 1.2* | 1.10* | 0.4 | 0.8 | 0.20 | 0.4 |
| | | % T | 92.9 | 92.9 | 92.80 | 92.9 | 93 | 93.00 | 93 |
| | 500 hr | b* | 0.17 | 0.2 | 0.16 | 0.17 | 0.17 | 0.16 | 0.18 |
| | | Haze | 0.7 | 1* | 0.70 | 0.7 | 0.4 | 0.20 | 0.5 |
| | | % T | 93 | 92.9 | 92.80 | 93 | 93 | 93.00 | 93 |
| | 1000 hr | b* | 0.18 | 0.21 | 0.15 | 0.2 | 0.17 | 0.15 | 0.19 |
| | | Haze | 0.7 | 1.2* | 0.90 | 0.5 | 1.2* | 0.20 | 1* |
| | | % T | 93 | 92.9 | 92.90 | 93 | 92.9 | 93.00 | 92.9 |
| 65° C./ | 0 hr | b* | 0.16 | 0.2 | 0.15 | 0.18 | 0.16 | 0.13 | 0.15 |
| 90% | | Haze | 0.8 | 1* | 0.10 | 1.2* | 0.8 | 0.20 | 0.5 |
| RH | | % T | 92.8 | 92.9 | 92.90 | 92.8 | 93 | 92.90 | 93 |
| | 250 hr | b* | 0.18 | 0.2 | 0.18 | 0.17 | 0.17 | 0.18 | 0.17 |
| | | Haze | 1.1* | 0.8 | 0.60 | 0.2 | 0.7 | 0.50 | 0.4 |
| | | % T | 92.9 | 92.9 | 92.90 | 93 | 93 | 93.00 | 93 |
| | 500 hr | b* | 0.17 | 0.19 | 0.15 | 0.17 | 0.18 | 0.13 | 0.17 |
| | | Haze | 0.4 | 1.1* | 0.30 | 0.4 | 0.7 | 0.30 | 0.4 |
| | | % T | 93 | 92.8 | 93.00 | 93 | 92.9 | 93.10 | 93 |
| | 1000 hr | b* | 0.19 | 0.19 | 0.16 | 0.2 | 0.2 | 0.14 | 0.21 |
| | | Haze | 1.1* | 4.4* | 1.0* | 0.3 | 1.6* | 0.30 | 1.1* |
| | | % T | 92.8 | 91.4 | 92.80 | 93 | 92.9 | 92.90 | 92.9 |
| 85° C./ | 0 hr | b* | — | — | 0.16 | — | — | 0.16 | — |
| 85% | | Haze | — | — | 0.20 | — | — | 0.10 | — |
| RH | | % T | — | — | 93.00 | — | — | 93.00 | — |
| | 250 hr | b* | — | — | 0.16 | — | — | 0.15 | — |
| | | Haze | — | — | 1.70* | — | — | 1.00* | — |
| | | % T | — | — | 92.60 | — | — | 92.80 | — |
| | 500 hr | b* | — | — | 0.17 | — | — | 0.17 | — |
| | | Haze | — | — | 1.50* | — | — | 1.90* | — |
| | | % T | — | — | 92.90 | — | — | 92.90 | — |
| | 1000 hr | b* | — | — | 0.21 | — | — | 0.20 | — |
| | | Haze | — | — | 2.80* | — | — | 2.30* | — |
| | | % T | — | — | 92.50 | — | — | 92.80 | — |

The optical properties of examples 3, 7, and 9 were not measured.

### Covalently Cross-Linked Silicone Optically Clear Adhesives

Examples of covalently cross-linked, addition-cured silicone OCAs were prepared using the materials described in Table 6.

TABLE 6
Materials

| Trade name | | |
|---|---|---|
| or | | |
| designation | Description | Supplier |
| Dehesive ® | High molecular weight (roughly 400,000) vinyl | Wacker Chemie |
| 948 | terminated polydimethylsiloxane dissolved in | (Munich, Germany) |
| | hydrocarbon solvent at 21% solids | |
| SYL-OFF ® | Multifunctional hydride crosslinker consisting of a | Dow Corning |
| 7488 | 50/50 blend of SYL-OFF ® 7408 and SYL-OFF ® | (Midland, MI) |
| | 7678 hydride functional crosslinkers | |
| SR545 | 60% solids solution of MQ resin in toluene | Momentive |
| | solvent | (Columbus, OH) |
| SIP 6831.2 | Platinum-Divinyltetramethyldisiloxane complex in | Gelest (Morrisville, |
| | xylene, 2.1-2.4% Pt concentration | PA) |
| DMS-H11 | Hydride-terminated polydimethylsiloxane, 7-10 cSt | Gelest (Morrisville, |
| | viscosity, molecular weight roughly 1,000 Da | PA) |

For ease of measurement, premixes of 10% 7488 crosslinker in heptane, 10% SIP 6831.2 Pt catalyst complex solution in heptane and 1% DMS-H11 in heptane were first prepared. The platinum catalyst was added last (at a level of 120 ppm Pt relative to vinyl functional silicone). Solutions corresponding to each silicone OCA formulation in Table 7 were prepared at 20% solids by diluting with heptane. OCAs containing 30 wt %, 40 wt % or 50 wt % MQ resin were prepared, with or without the DMS-H11 hydride terminated polydimethylsiloxane. For the samples containing the hydride-terminated silicone, the molar ratio of vinyl-terminated silicone to hydride-terminated silicone was 2/1.

TABLE 7
Covalently Cross-linked Silicone OCA formulations

| | | | | | 1% | | |
|---|---|---|---|---|---|---|---|
| | | | | | DMS- | | |
| | | | 10% 7488 | | H11 in | | 10% SIP |
| | | 948 | in heptane | SR545 | heptane | Heptane | 6831.2 in |
| Ex. | Formulation | (g) | (g) | (g) | (g) | (g) | heptane (g) |
| 11 | 70/30 vinyl | 60 | 0.854 | 9.00 | 0 | 19.90 | 0.672 |
| | silicone/MQ | | | | | | |
| 12 | 70/30 vinyl | 60 | 0.427 | 9.00 | 1.638 | 18.48 | 0.672 |
| | silicone/MQ, 2/1 | | | | | | |
| | vinyl silicone/DMS- | | | | | | |
| | H11 | | | | | | |
| 13 | 60/40 vinyl | 50 | 0.712 | 11.67 | 0 | 24.95 | 0.560 |
| | silicone/MQ | | | | | | |
| 14 | 60/40 vinyl | 50 | 0.356 | 11.67 | 1.365 | 24.01 | 0.560 |
| | silicone/MQ, 2/1 | | | | | | |
| | vinyl silicone/DMS- | | | | | | |
| | H11 | | | | | | |
| 15 | 50/50 vinyl | 40 | 0.570 | 14.00 | 0 | 29.27 | 0.448 |
| | silicone/MQ | | | | | | |
| 16 | 50/50 vinyl | 40 | 0.285 | 14.00 | 1.092 | 28.83 | 0.448 |
| | silicone/MQ, 2/1 | | | | | | |
| | vinyl silicone/DMS- | | | | | | |
| | H11 | | | | | | |

The silicone OCA solutions were coated onto 2 mil SILFLU S 50M 1R88002 fluorosilicone-coated PET liner (Siliconature S.p.A., Italy) using a knife coater with the gap set to obtain a 2 mil thick OCA after drying and curing. The coatings were placed in an oven at 110° C. for 5 minutes in order to remove the solvent and cure the OCA. A release liner was then dry laminated to the free surface of the OCA coatings.

The shear storage modulus at −25° C., −20° C., 0° C., 25° C., 60° C., 65° C. and the T_{g} of the silicone OCAs were determined by the methods described in the rheology test method section. The shear storage modulus at −25° C., −20° C., 0° C., 25° C., 60° C., 65° C. and the T_{g} of the silicone OCAs were determined by the methods described in the rheology test method section. The shear storage modulus and T_{g} results are presented in Table 8. It is preferred that each of the samples have a shear modulus below 2 MPa. Creep testing was conducted as described above and the results are presented in Table 9. It is preferred that even when stressed at 90 kPa, the shear strain is more than 300% and when stressed at 95 kPa followed by removal of the applied stress, the recovery is more than 50% of the original strain. The results of 180° Peel and T-Peel testing of covalently cross-linked silicones are presented in Table 9.

TABLE 8
Rheology

| | Shear Storage Modulus (MPa) | | | | | | Tg from |
|---|---|---|---|---|---|---|---|
| Example | −25° C. | −20° C. | 0° C. | 25° C. | 60° C. | 65° C. | Tan(Delta) |
| 11 | 0.096 | 0.091 | 0.077 | 0.073 | 0.073 | 0.073 | −73.94 |
| 12 | 0.109 | 0.102 | 0.087 | 0.081 | 0.077 | 0.077 | −70.11 |
| 13 | 0.606 | 0.441 | 0.170 | 0.096 | 0.074 | 0.073 | −22.56 |
| 14 | 0.607 | 0.432 | 0.147 | 0.072 | 0.049 | 0.048 | −15.85 |
| 15 | 0.713 | 0.516 | 0.156 | 0.068 | 0.045 | 0.043 | −14.13 |
| 16 | 1.419 | 1.037 | 0.267 | 0.090 | 0.050 | 0.048 | −3.17 |

TABLE 9
Creep, Shear Strain and Peel

| | | | | 180° | | | |
|---|---|---|---|---|---|---|---|
| | | | Shear Strain | Peel | 180° | T-Peel | |
| | Creep at 95 kPa | | (between | on | Peel - | between | T-Peel |
| | Max | | PET, RT at | glass | Failure | PET | Failure |
| Example | Strain | Recovery | 90 kPa) | (g/in) | Mode | (g/in) | Mode |
| 11 | 122.329 | 99.52% | 936 | 80.8 | Adhesive | 78.5 | Adhesive |
| 12 | 182.531 | 98.31% | 862 | 110.4 | Adhesive | 84.7 | Adhesive |
| 13 | 143.772 | 99.43% | 949 | 633.5 | Adhesive | 149.3 | Adhesive |
| 14 | 501.845 | 91.50% | 992 | 648.4 | Adhesive | 224.5 | 2-bond |
| 15 | 226.547 | 98.29% | 882 | 1096.3 | Adhesive | 481.5 | Adhesive |
| 16 | 484.63 | 94.59% | 1012 | 1009.7 | Adhesive | 609.6 | Adhesive |

Although the present invention has been described with reference to preferred embodiments, workers skilled in the art will recognize that changes may be made in form and detail without departing from the spirit and scope of the invention.

What is claimed is:

1. An assembly layer for a flexible device, wherein the assembly layer is derived from precursors comprising:
a physically cross-linked silicone elastomer or a covalently cross-linked silicone elastomer forming reagent mixture; and
a MQ resin;
wherein within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

2. The assembly layer of claim 1, wherein the assembly layer is optically clear.

3. The assembly layer of claim 2, wherein when the assembly layer is placed between two transparent substrates and made into a laminate, the laminate has a haze value of less than about 5% after the laminate is placed in an environment of 70° C./90% relative humidity for 72 hours and then cooled to room temperature.

4. The assembly layer of claim 1, wherein the flexible device is an electronic display device.

5. The assembly layer of claim 1, wherein the covalently cross-linked silicone elastomer forming reagent mixture comprises a catalyst.

6. The assembly layer of claim 1, wherein the assembly layer comprises between about 10 parts and about 50 parts MQ resin.

7. A laminate comprising:
a first flexible substrate;
a second flexible substrate; and
an assembly layer positioned between and in contact with the first flexible substrate and the second flexible substrate, wherein the assembly layer is derived from precursors that comprise:
at least one of a physically cross-linked silicone elastomer and a covalently cross-linked silicone elastomer forming reagent mixture; and
a MQ resin;
wherein within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

8. The laminate of claim 7, wherein the assembly layer is optically clear.

9. The laminate of claim 7, wherein at least one of the first and second substrates is optically clear.

10. The laminate of claim 9, wherein the laminate has a haze value of less than about 5% after the laminate is placed in an environment of 70° C./90% relative humidity for 72 hours and then cooled to room temperature.

11. The laminate of claim 7, wherein the assembly layer comprises between about 10 parts and about 50 parts MQ resin.

12. The laminate of claim 7, wherein the laminate does not exhibit failure when placed within a channel forcing a radius of curvature of less than about 15 mm over a period of 24 hours room temperature.

13. The laminate of claim 12, wherein the laminate returns to an included angle of at least about 130 degrees after removal from the channel after the 24 hour period room temperature.

14. The laminate of claim 7, wherein the laminate does not exhibit failure when subjected to a dynamic folding test room temperature of about 10,000 cycles of folding with a radius of curvature of less than about 15 mm.

15. A method of adhering a first substrate and a second substrate, wherein both of the first and the second substrate is flexible, the method comprising:
positioning an assembly layer between the first substrate and the second substrate to form a flexible laminate, wherein the assembly layer is derived from precursors that comprise:
at least one of a physically cross-linked silicone elastomer and a covalently cross-linked silicone elastomer forming reagent mixture; and
a MQ resin;
wherein within a temperature range of between about −30° C. to about 90° C., the assembly layer has a shear storage modulus at a frequency of 1 Hz that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress; and
applying at least one of pressure and heat to form a laminate.

16. The method of claim 15, wherein the assembly layer is optically clear.

17. The method of claim 15, wherein the laminate has a haze value of less than about 5% after the laminate is placed in an environment of 70° C./90% relative humidity for 72 hours and then cooled to room temperature.

18. The method of claim 15, wherein the laminate does not exhibit failure when placed within a channel forcing a radius of curvature of less than about 15 mm over a period of 24 hours room temperature.

19. The method of claim 18, wherein the laminate returns to an included angle of at least about 130 degrees after removal from the channel after the 24 hour period room temperature.

20. The method of claim 15, wherein the laminate does not exhibit failure when subjected to a dynamic folding test room temperature of greater than about 10,000 cycles of folding with a radius of curvature of less than about 15 mm.
